(19) United States
(12) Patent Application Publication
(10) Pub. No.: US 2009/0132788 A1
(43) Pub. Date: May 21, 2009

(54) CONTROL SYSTEM WITH MULTIPLE PROCESSORS AND CONTROL METHOD THEREOF

(75) Inventor: KIM-YEUNG SIP, Shenzhen City (CN)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Taipei Hsien (TW)

(21) Appl. No.: 12/271,938

(22) Filed: Nov. 17, 2008

(30) Foreign Application Priority Data
Nov. 16, 2007 (CN) 200710202568.1

(51) Int. Cl. G06F 15/76; G06F 9/06

(52) U.S. Cl. 712/31; 712/E09.003

(57) ABSTRACT

A control system comprises a master processor, a main memory and multiple slave processors. The main memory stores programs, and a signal-program table for storing relationships between the programs and input signals. The multiple slave processors are configured for sending input signals in response to external stimuli to the master processor, and executing programs corresponding to the input signals sent back by the master processor. The master processor is configured for interrogating the signal-program table to determine the corresponding programs according to one of the input signals, searching the main memory for acquiring the corresponding programs, determining which one or more of the multiple slave processors should execute the corresponding programs, and transmitting each of the corresponding programs to the one or more of the multiple slave processors. A related control method is also provided.

### BACKGROUND

1. Field of the Disclosure

The present disclosure relates to control systems, and particularly to a control system with multiple processors and a control method thereof.

2. Description of Related Art

Some electronic apparatus, for example robotic toys, have multiple processors. The most powerful, and likely the most expensive, of the multiple processors is usually the “brain” of the robotic toy. The other less powerful and cheaper processors control the sensors and other subsystems, such as the motors, of the robotic toy. Because different sensors and subsystems perform different tasks or action, specific software programs are required to be executed by each processor controlling the different sensors or subsystems of the robotic toy. These programs are stored in external memory chips attached to each processor. As a result, large numbers of external memory chips are needed for the robotic toy. Accordingly, the complexity and cost of the robotic toy are significant.

Therefore, a heretofore unaddressed need exists in the industry to overcome the aforementioned deficiencies and inadequacies.

### BRIEF DESCRIPTION OF THE DRAWINGS

FIG. 1 is a schematic diagram of a control system having multiple processors in accordance with an exemplary embodiment of the present disclosure.

FIG. 2 is a schematic diagram of a control system having multiple processors in accordance with an alternative embodiment of the present disclosure.

FIG. 3 is a flowchart of a control method utilized by the control system of FIG. 1 or FIG. 2.

### DETAILED DESCRIPTION

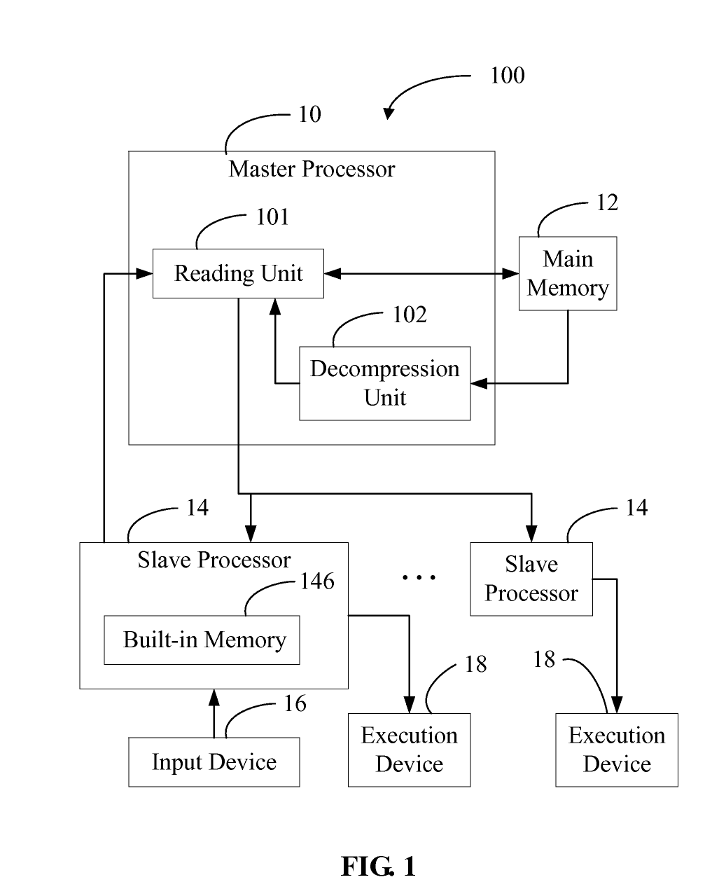

In an exemplary embodiment of the present disclosure, FIG. 1 shows a control system 100 comprises a master processor 10, a main memory 12, and multiple slave processors 14. The main memory 12 is connected to the master processor 10. Each of the slave processors 14 is connected to the master processor 10. A slave processor 14 may or may not be connected to an input device 16 depending on the purpose of the slave processor 14. Inputs are considered as external stimuli, such as audio, sight, touch, etc. and are not internal feedback inputs such as inputs fed back from sensors indicating the position of motors, etc. Each of the slave processors 14 is connected to at least one execution device 18.

The input devices 16 are configured for generating an input signal in response to external stimuli. As mentioned above, the external stimuli may be one selected from a group comprising of an audio signal, a visual signal or other sensory perception, such as temperature as pressure. The execution device 18 performs an action or actions, under the control of the corresponding slave processor 14, in response to the external stimuli.

The main memory 12 stores multiple programs, a signal-program table and a program-processor table. The signal-program table and the program-processor table are look-up tables. The signal-program table stores relationships between the programs and the input signals. The program-processor table stores relationships between the slave processors and the programs.

The slave processors 14 receive the input signal from the input device 16, send the input signal to the master processor 10 for acquiring one or more programs corresponding to the input signal. The one or more corresponding programs will be sent to the slave processor 14 by the master processor 10. The slave processor 10 will execute the one or more corresponding programs sent back by the master processor 10 to control the execution device 18.

The master processor 10 comprises a reading unit 101 and decompression unit 102. The reading unit 101 is configured for interrogating the signal-program table to determine one or more programs corresponding to the input signal, and searching the main memory 12 for acquiring the one or more corresponding programs.

The reading unit 101 further interrogates the program-processor table to determine which one or more of the slave processors 14 should execute the corresponding programs corresponding to the input signal, and transmits each of the corresponding programs to the one or more of the slave processors 14. The decompression unit 102 decompresses any compressed programs corresponding to the input signal.

Each of the slave processors 14 can further comprises a built-in memory 146 for temporarily storing the corresponding to programs needed for execution.

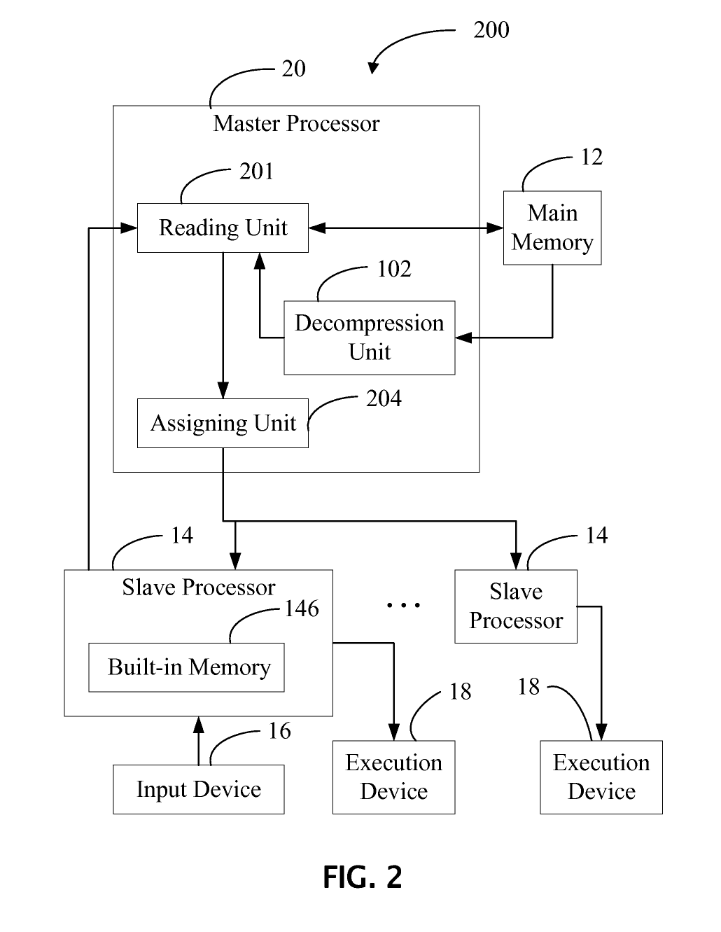

In another exemplary embodiment of the present disclosure, FIG. 2 shows a controlling system 200 having a master processor 20 and an assigning unit 204. In this embodiment, the main memory 12 of a control system 200 does not incorporate the program-processor table, instead, each of the programs stored in the main memory 12 has a tag indicating which one or more of the slave processors 14 should execute the corresponding programs. The assigning unit 204 reads the tag of each of the programs corresponding to the input signal, acquired by the reading unit 201 of the master processor 20, to determine which one or more of the slave processors 14 should execute the corresponding acquired programs, and transmits each of the acquired programs to the one or more of the slave processors 14, correspondingly.

The control system can be used in computers or other electronic apparatus having multiple slave processors 14. Because the programs of all the slave processors 14 are centralized and stored in the main memory 12, the size of the memory and possibly the number of external memory chips for the slave processors 14 are reduced. The controls programs are selectively distributed or loaded in the memory of the slave processors as the need arises. Furthermore, because all programs are stored in the main memory 12, the programs can be updated easily if or when necessary.

The benefits of the control system are particularly realized when a larger number of slave processors 14, are used in the control system. Referring to FIG. 4, one example can be illustrated using a robotic design. In this robotic example, the input device 16 is one selected from a group comprising of a camera, a microphone or a touch sensor, and the execution device 18 is one selected from a group comprising of a motor, a voice generator or a light generator.

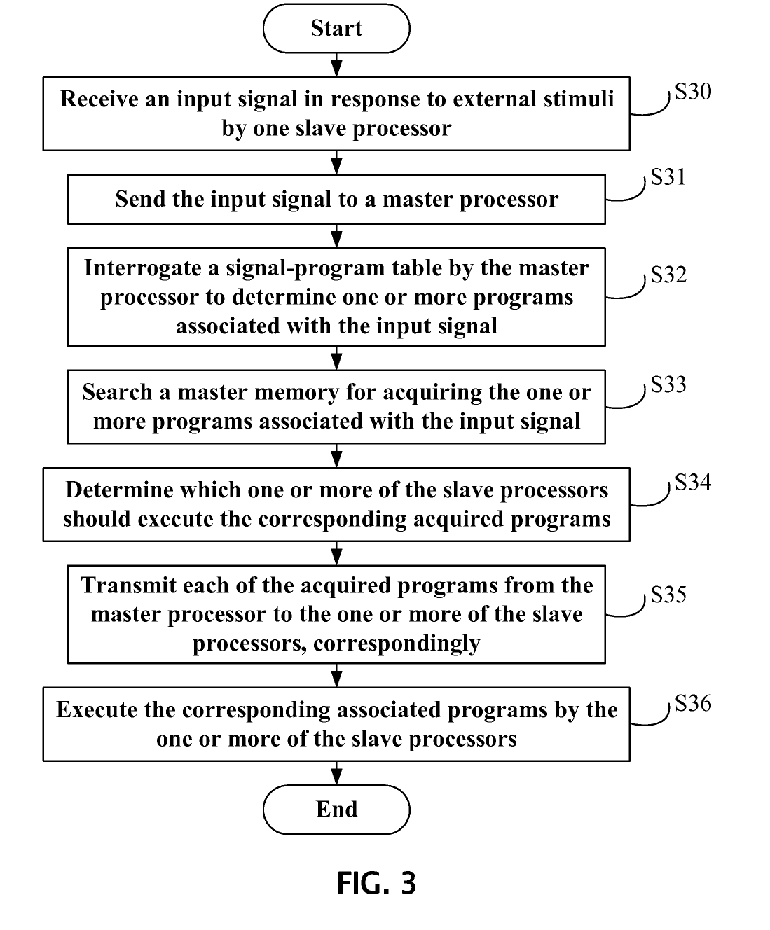

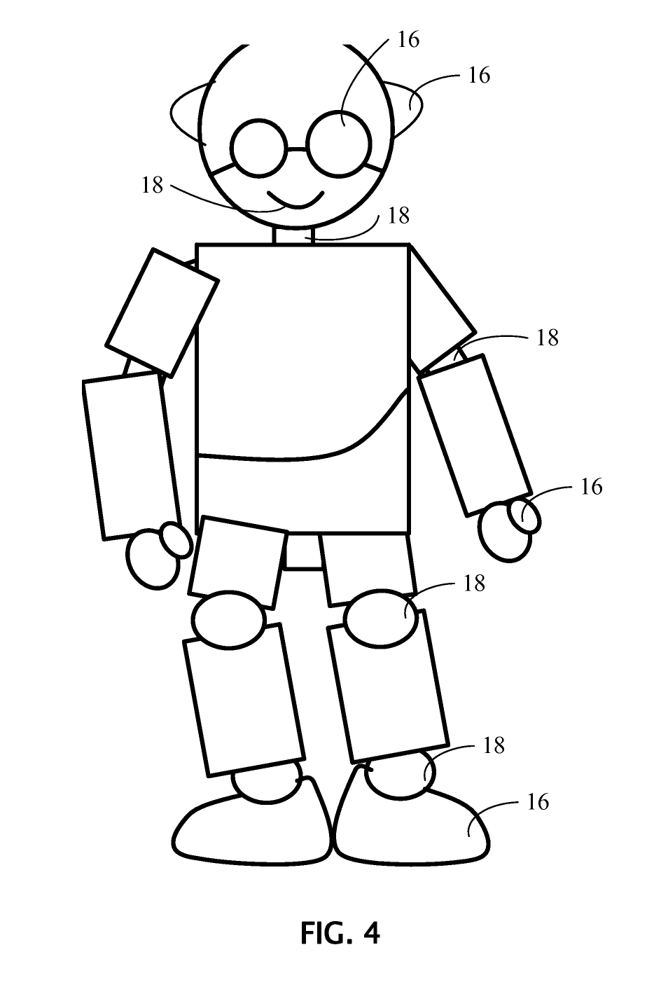

FIG. 3 is a flowchart of a control method utilized by the control system of FIG. 1 and FIG. 2. In step S30, one of the slave processors receives an input signal generated by the input device 16 in response to external stimuli.

In step S31, the one of the slave processors sends the input signal to the master processor.

In step S32, the master processor interrogates a signal-program table to determine one or more programs corresponding to the input signal.

In step S33, the master processor searches the main memory for acquiring the one or more programs corresponding to the input signal.

In step S34, the master processor determines which one or more of the slave processors should execute the corresponding acquired programs.

In step S35, the master processor transmits each of the acquired programs to the one or more of the slave processors, correspondingly.

In step S36, the one or more of the slave processors execute the corresponding acquired programs.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A control system comprising:
a master processor;
a main memory for storing programs and a signal-program table for storing relationships between the programs and input signals; and
multiple slave processors configured for sending input signals to the master processor in response to external stimuli, and executing programs corresponding to the input signals sent back by the master processor;
wherein the master processor interrogates the signal-program table to determine the corresponding programs according to one of the input signals, searches the main memory for acquiring the corresponding programs, determines which one or more of the multiple slave processors should execute the corresponding programs, and transmits each of the corresponding programs to the one or more of the multiple slave processors.

2. The control system as claimed in claim 1, wherein the master processor is further configured for decompressing any compressed programs.

3. The robotic apparatus as claimed in claim 1, wherein the main memory further stores a program-processor table for recording relationships between the multiple slave processors and the corresponding programs, the master processor interrogates the program-processor table to determine which one or more of the multiple slave processors should execute the corresponding programs.

4. The control system as claimed in claim 1, wherein each of the one or more programs has a tag, the master processor reads the tag of each of the corresponding programs to determine which one or more of the multiple slave processors should execute the corresponding programs.

5. The robotic apparatus as claimed in claim 1, wherein the external stimuli is one selected from a group comprising of an audio signal, a visual signal or other sensory perception.

6. The robotic apparatus as claimed in claim 1, wherein each of the slave processors comprises a built-in memory for temporarily storing the corresponding programs needed for execution.

7. A control method comprising:
providing a main memory for storing multiple programs and a signal-program table for recoding relationships between the programs and input signals;
sending an input signal from one of the multiple slave processors to a master processor in response to external stimuli;
interrogating the signal-program table to determine one or more programs corresponding to the input signal;
searching the main memory for acquiring the corresponding programs by the master processor;
determining which one or more of the multiple slave processors should execute the corresponding programs;
transmitting each of the corresponding programs from the master processor to the one or more of the multiple slave processors; and
executing the corresponding programs by the one or more of the multiple slave processors.

8. The control method as claimed in claim 7, further comprising: decompressing any compressed programs.

9. The control method as claimed in claim 7, wherein a detailed step of determining the one or more of the multiple slave processors is: presetting a program-processor table for recording relationships between the multiple slave processors and the corresponding programs; and interrogating the program-processor table to determine which one or more of the multiple slave processors should execute the corresponding programs.

10. The control method as claimed in claim 7, wherein a detailed step of determining the one or more of the multiple slave processors is: presetting a tag to each of the corresponding programs; and reading the tag of each of the corresponding programs to determine which one or more of the multiple slave processors should execute the corresponding programs.

11. The control method as claimed in claim 7, further comprising: providing a built-in memory attached to each of the multiple slave processors for temporarily storing the corresponding programs needed for execution.
